(19) United States
(12) Patent Application Publication
(10) Pub. No.: US 2006/0049643 A1
(43) Pub. Date: Mar. 9, 2006

(54) Latch release mechanism

(76) Inventor: Jerome Pierre Roussel, Colmar (FR)

Correspondence Address: CARLSON, GASKEY & OLDS, P.C., 400 WEST MAPLE ROAD, SUITE 350, BIRMINGHAM, MI, 48009, US

(21) Appl. No.: 11/221,363

(22) Filed: Sep. 7, 2005

(30) Foreign Application Priority Data
Sep. 8, 2004 (EP) EP 04255440.2

(51) Int. Cl. E05C 3/06

(52) U.S. Cl. 292/216

(57) ABSTRACT

A latch release mechanism for a vehicle door latch includes a release lever arranged to transmit an input from a release actuator to a pawl of the latch and lift the pawl and release a retention formation of the latch. The release lever further includes an attachment formation to permit the attachment of a release linkage for a second retention formation. The release lever is further connected to an auxiliary release lever for synchronous motion with the release lever. The auxiliary release lever includes a second attachment formation to permit the attachment of a release linkage for a third retention formation, and the release lever is a pawl lifter.

### REFERENCE TO RELATED APPLICATION

This application claims priority to European Patent Application EP 04255440.2 filed on Sep. 8, 2004.

### BACKGROUND OF THE INVENTION

The present invention relates generally to a latch release mechanism for a vehicle door latch.

Light commercial vehicles such as panel vans (i.e., vans in which the load space is enclosed) typically include a relatively large rear opening that is closeable by two rear doors hinged to a rear most edge of each side of the van. A latch is typically provided part way up a shut-face of one of the rear doors. The latch is arranged to latch with a complementary striker provided on a shut face of the other of the rear doors when the doors are closed. Typically, the latch may also operate shoot bolts or supplementary latches which are fitted to the upper and lower edges of the door to which the latch is fitted and which are arranged to engage in a complementary hole or striker in a door surround. The shoot bolts or supplementary latches provide additional latching strength to the doors when closed to resist flexing of the relatively tall doors when the vehicle is in motion and to resist any attempts to force the latched doors open.

Prior art mechanisms for the operation of the shoot bolts or the supplementary latches have been complex and therefore costly to manufacture and install.

The present invention seeks to overcome, or at least mitigate, the problems of the prior art.

### SUMMARY OF THE INVENTION

Accordingly, one aspect of the present invention provides a latch release mechanism for a vehicle door latch including a release lever arranged to transmit an input from a release actuator to a pawl of the latch and thereby lift the pawl and release a retention formation of the latch. The release lever further includes an attachment formation to permit the attachment of a release linkage for a second retention formation, and the release lever is further connected to an auxiliary release lever for synchronous motion with the release lever. The auxiliary release lever includes a second attachment formation to permit the attachment of a release linkage for a third retention formation. The release lever is a pawl lifter.

A second aspect of the present invention provides a latch release mechanism for a vehicle door latch including a release lever arranged to transmit an input from a release actuator to a pawl of the latch and thereby lift the pawl and release a retention formation of the latch. The release lever further includes an attachment formation to permit the attachment of a release linkage for a second retention formation. The release lever is further connected to an auxiliary release lever for synchronous motion with the release lever. The auxiliary release lever includes a second attachment formation to permit the attachment of another release linkage for a third retention formation. At least one attachment formation is provided on at least one of the release lever or the auxiliary release lever configured to attach a Bowden cable thereto.

A third aspect of the present invention provides a door latch array comprising a primary latch incorporating a latch release mechanism for a vehicle door latch including a release lever arranged to transmit an input from a release actuator to a pawl of the latch and thereby lift the pawl and release a retention formation of the latch. The release lever further includes an attachment formation to permit the attachment of a release linkage for a second retention formation. The release lever is further connected to an auxiliary release lever for synchronous motion with the release lever. The auxiliary release lever includes a second attachment formation to permit the attachment of another release linkage for a third retention formation. The release lever is a pawl lifter. The array further includes a second retention formation and a third retention formation, and a first linkage and a second linkage connect the second retention formation and the third retention, respectively, formation to the primary latch.

### BRIEF DESCRIPTION OF THE DRAWINGS

Embodiments of the present invention will now be described, by way of example only, with reference to the accompanying drawings in which:

FIG. 1A is a view of a rear doors of a van or a light commercial vehicle illustrating an arrangement of a handle and latches;

FIG. 1B is an exploded view of an alternative arrangement of a handle, latches and strikers when mounted on the rear doors of a high roof van;

FIG. 1C is an exploded view of another alternative arrangement of a handle, latches and strikers when mounted on the rear doors of a low roof van;

FIG. 1D is an exploded view of a further alternative arrangement of a handle, latches and strikers when mounted on the rear doors of a small van;

FIG. 2 is a side view of a latch incorporating a release mechanism according to the present invention in a latched state, with some parts removed for clarity;

FIG. 3 is an isometric view of the latch of FIG. 2 with further parts removed;

FIG. 4 is an isometric view of the other side of the latch of FIG. 2 with parts removed for clarity;

FIG. 5 is an isometric view of the latch of FIG. 4 with a number of additional parts in place;

FIG. 6 is an isometric view of the latch and striker of FIG. 5 with further parts in place;

FIG. 7 is a side view of a pawl and a pawl lifter of the latch of FIG. 2; and

FIG. 8 is an isometric view of the pawl and the pawl lifter of FIG. 7.

### DETAILED DESCRIPTION OF THE PREFERRED EMBODIMENT

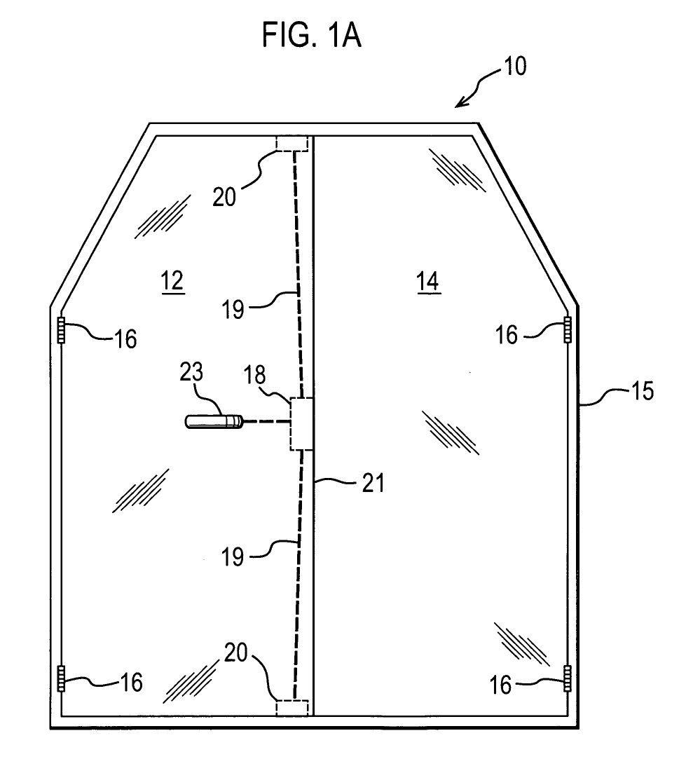

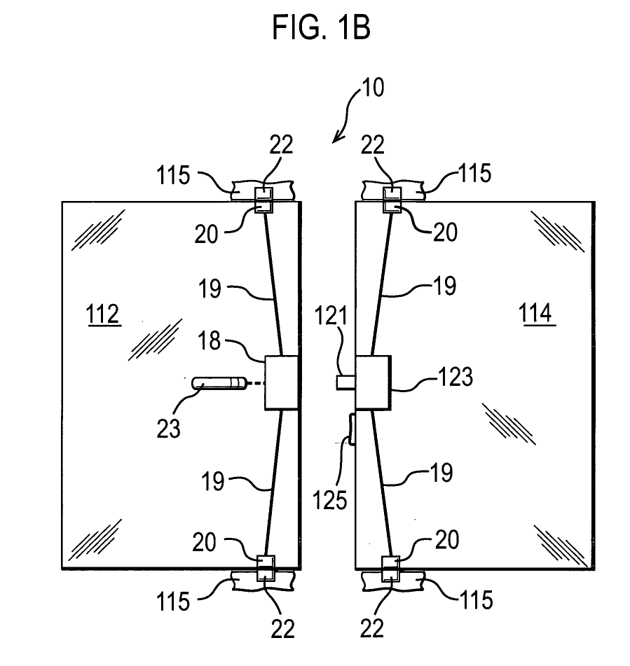

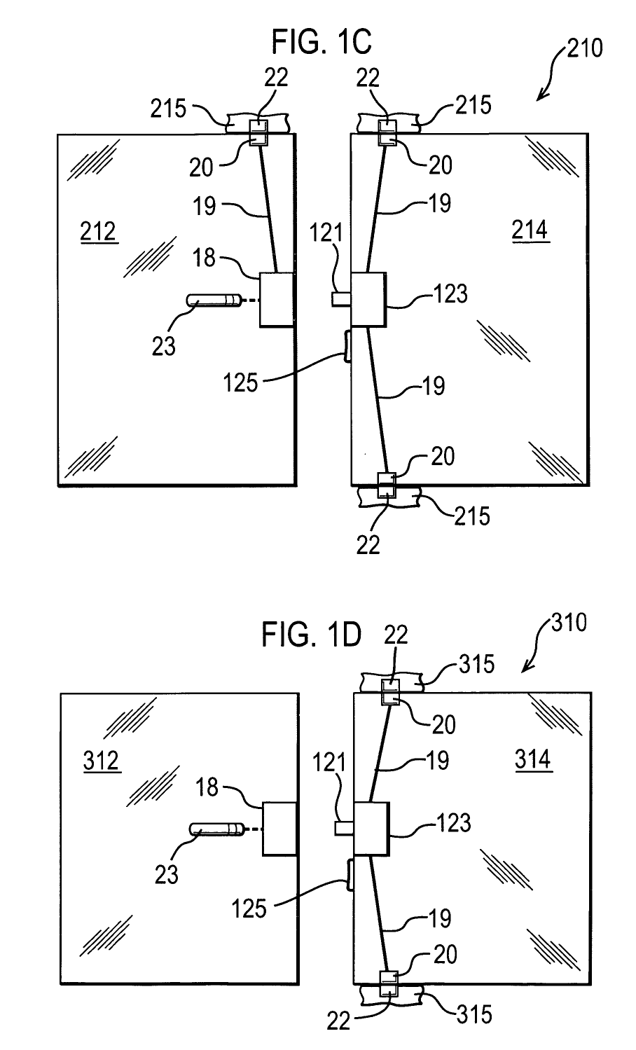

Referring to FIG. 1A, a light commercial vehicle, such as a van 10, incorporates a latch having a latch release mechanism according to the present invention. Only the rear of the van 10 is visible and this includes a first rear door 12 and a second rear door 14 pivotally mounted to a door surround 15 by hinges 16. In use, the first rear door 12 is opened first, followed by the second rear door 14 in order to gain full access to the vehicle load area. A primary latch 18 is mounted proximate a shut-face 21 of the first rear door 12 to engage and releaseably retain a complementary striker (not shown) provided on an opposed shut-face of the second rear door 14. The primary latch 18 is lockable to provide some protection from unauthorized access to the load space of the vehicle.

Linkages 19, such as connecting rods or Bowden cables, extend from the top and the bottom of the primary latch 18 to connect the primary latch 18 with secondary latches 20 mounted near the top and the bottom of the first rear door 12. The secondary latches 20 are positioned to engage complementary strikers 22 (see FIGS. 1B, 1C and 1D) mounted to the door surround 15 of the van 10. Thus, when the first rear door 12 is closed, it is latched to both the second rear door 14 and to the door surround 15, thereby securely retaining both the first rear door 12 and the second rear door 14 in a closed position relative to the door surround 15. When the primary latch 18 is unlocked, pulling on an outside release handle 23 simultaneously releases both the primary latch 18 and the secondary latches 20 (by virtue of the linkages 19).

FIGS. 1B, 1C and 1D show alternative configurations of the secondary latches 20 and strikers when fitted to high roof line, low roof line and small vans 110, 210 and 310, respectively. In each case, the primary latch 18 is fitted to a first door 112, 212 and 312 and a corresponding primary striker 121 is mounted to a central opening plate 123 of a second door 114, 214 and 314, respectively. In each configuration, a secondary release handle 125 is mounted to the shut face of the second door 114, 214 and 314 so that it is only accessible to a vehicle user when the first door 112, 212 and 312, respectively, is open. The secondary release handle 125 is operably connected to a release mechanism (not shown) within the central opening plate 123 such that actuation of the secondary release handle 125 causes the release of the secondary latches 20 from the strikers 22 mounted on the door surround 115, 215 and 315.

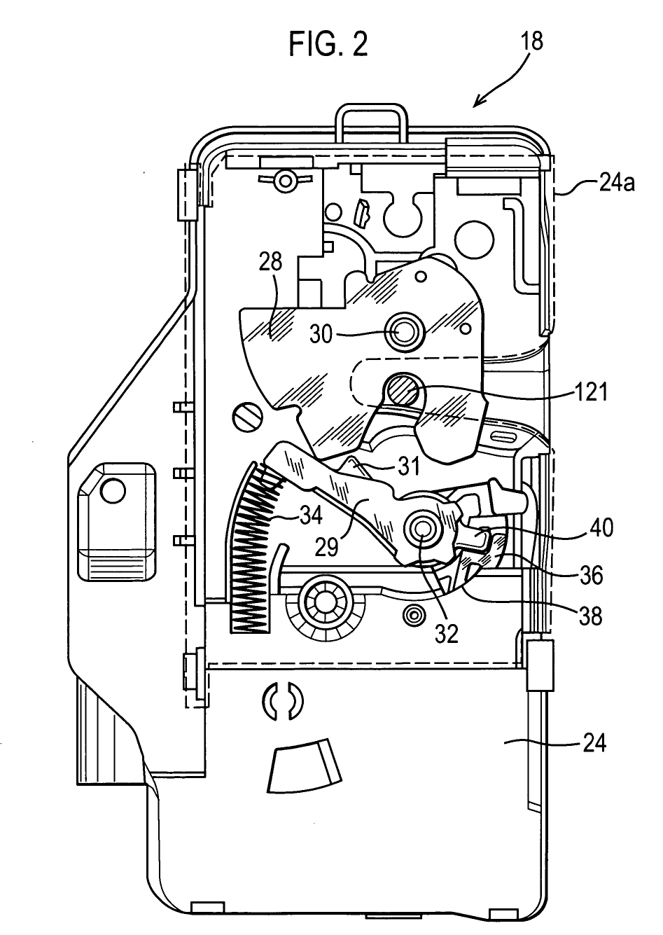

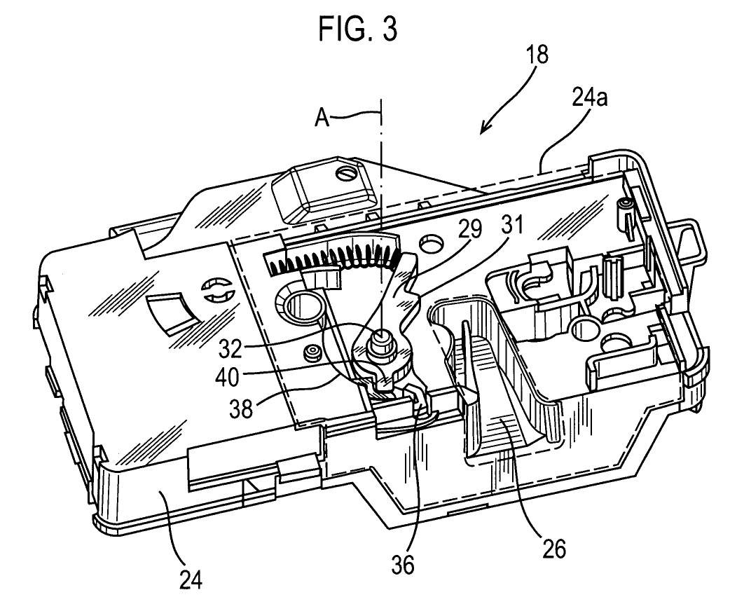

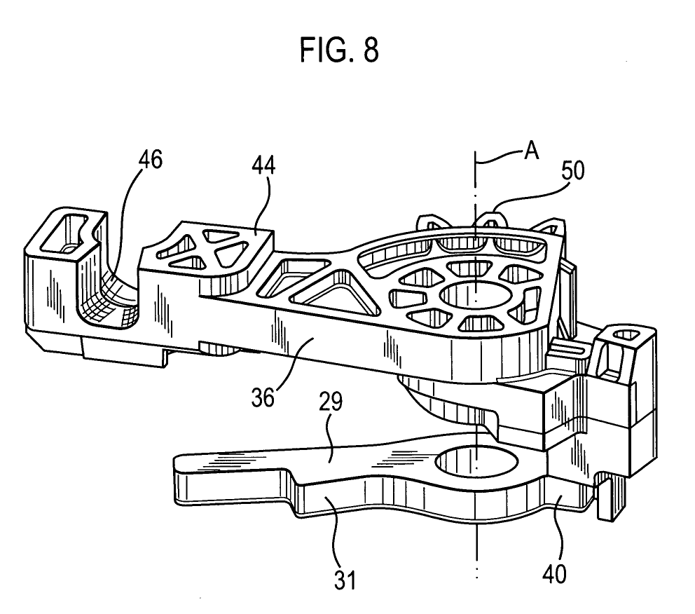

Turning to FIGS. 2 to 8, various portions of the primary latch 18 incorporating a release mechanism according to a first embodiment of the present invention are shown. The primary latch 18 includes a housing 24 provided with a mouth 26 arranged to receive the primary striker 121. A pressed metal part 24a of the housing 24 that covers the generally upper part of the primary latch 18 when viewed in FIG. 2 and provides a large proportion of the structural strength of the primary latch 18 has been removed from FIGS. 2 and 3, but is shown in phantom.

A striker retention means (latch bolt) in the form of a rotatable claw 28 is pivotally mounted within the housing 24 by a pin 30. The claw 28 is resiliently biased toward the open position, but is shown in FIG. 2 in a closed and a latched position.

When the primary striker 121 is introduced into the mouth 26, the claw 28 is caused to rotate and be retained by a pawl tooth 31 of a pawl 29 of the latch mechanism, thereby releaseably retaining the claw 28 as shown in FIG. 2.

In FIG. 2, the pawl 29 is illustrated with a plastics sheath portion thereof in place, and in FIGS. 3, 7 and 8, only the metallic portion of the pawl 29 is illustrated. The pawl 29 is pivotable on a pin 32 about an axis A and biased into contact with the claw 28 by a spring 34.

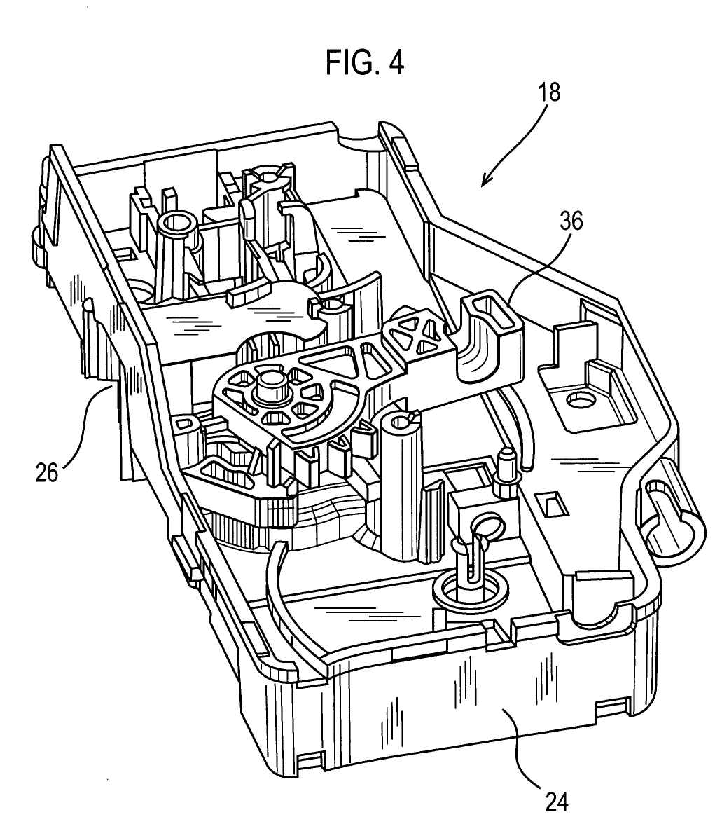

With reference to FIGS. 4, 7 and 8, a release lever in the form of pawl lifter 36 is rotationally mounted about the pin 32 coaxially with the pawl 29, but on the other side of housing 24 to the pawl 29. However, a portion of the pawl lifter 36 is just visible through an opening 38 in the housing 24 when viewed in FIGS. 2 and 3.

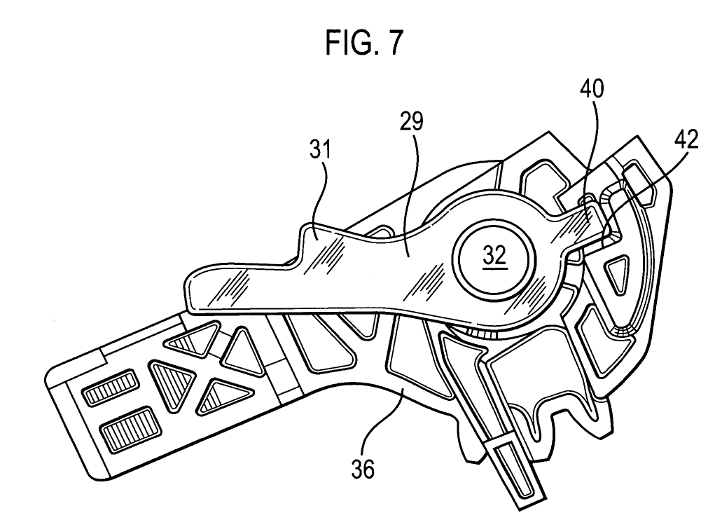

As can be seen most clearly from FIG. 7, the pawl 29 includes an engagement lug 40 that extends radially from the axis of rotation about the pin 32 in a direction that is generally opposite from the arm of the pawl 29 that is provided with pawl tooth 31. A complementary abutment surface 42 is provided on the pawl lifter 36 that extends generally in the direction of the axis of rotation A of the pawl lifter 36 so that when viewed in FIG. 7, counter-clockwise rotation of the pawl lifter 36 causes counter-clockwise rotation of the pawl 29 when the complementary abutment surface 42 contacts the engagement lug 40. However, the pawl 29 may rotate independently counter-clockwise of the pawl lifter 36 through a considerable range of motion so that the pawl 29 can ride over the surface of the claw 28 during re-latching of the primary latch 18 without a corresponding movement of the pawl lifter 36 occurring. In other words, there is a lost motion connection between the pawl 29 and the pawl lifter 36.

Referring now to FIGS. 4, 5 and 8, the pawl lifter 36 is further provided with an arm 44 extending generally radially away from the axis of rotation A about the pin 32. Towards the radially outermost end of the arm 44, an attachment formation in the form of a half-cup shaped recess 46 is provided that permits a complementary head (not shown) of an inner (not shown) of a Bowden cable 48 to be clipped into place on the pawl lifter 36. The pawl lifter 36 further includes a gear quadrant 50 having three gear teeth facing in a radially outward direction from the center of rotation of the pawl lifter 36.

An auxiliary release lever 52 is further mounted to the latch housing 24 by a pin (not shown) for rotation about an axis B. The axis B is substantially parallel to the axis A. The auxiliary release lever 52 includes an arm 54 that is substantially a mirror image of the arm 44 of the pawl lifter 36 and is also provided with a half-cup shaped recess 56 into which a head (not shown) of an inner (not shown) of a second Bowden cable 58 fits.

The auxiliary release lever 52 additionally includes a gear quadrant 60 that is arranged to mesh with the gear quadrant 50 of the pawl lifter 36 such that clockwise rotation of the pawl lifter 36 results in counter-clockwise rotation of the auxiliary release lever 52 and vice-versa.

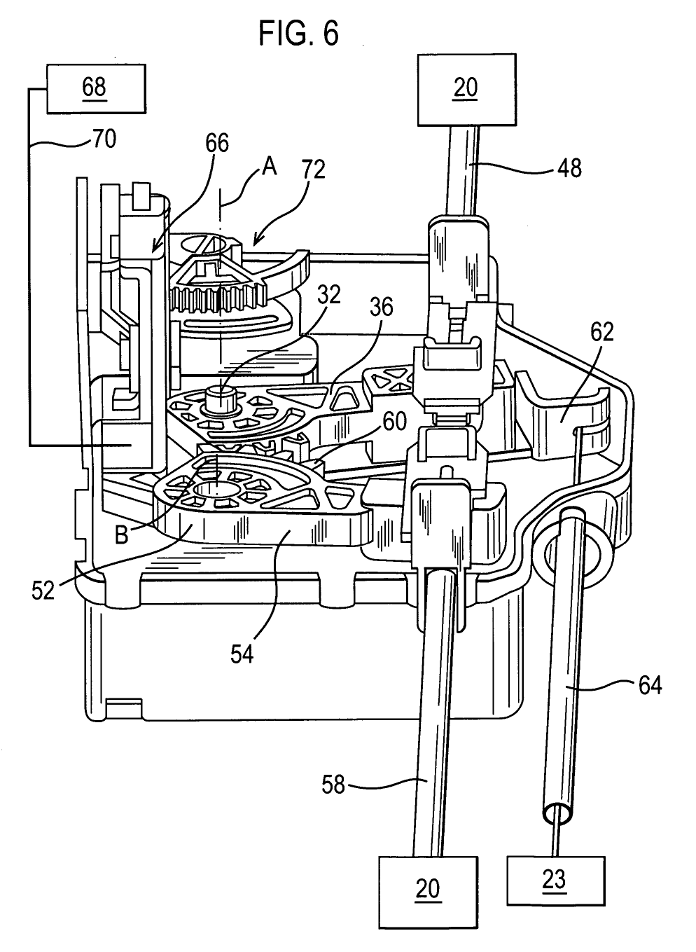

Thus, with reference to FIG. 6, if the pawl lifter 36 rotates clockwise, then the inner of Bowden cable 48 is drawn out of the paper relative to the sheath of the Bowden cable, and the inner of the Bowden cable 58 is drawn into the paper relative to its sheath.

With reference to FIG. 6, the latch mechanism further includes an outside release lever 62 that is connected to a release actuator in the form of an outside handle 23 by a third Bowden cable 64. The latch mechanism also includes an inside release mechanism 66 is connected to a further release actuator in the form of an inside handle 68 by a suitable linkage 70 (both illustrated schematically).

A suitable locking mechanism (not visible) is provided to selectively block or break the transmission path from one or both of the inside handle 68 and the outside handle 23 in response to inputs from a key barrel, and in some embodiments from an interior button such as a sill button. The primary latch 18 further includes, in this embodiment, a power locking mechanism 72 connected to a suitable electronic control system to enable the primary latch 18 to be remotely locked and unlocked by using a remote keyless entry device (not shown), for example. In certain embodiments, the primary latch 18 may be provided with a child-safety mechanism selectable to prevent the release of the primary latch 18 from the interior and a power unlatching mechanism that uses a release actuator in the form of an electric motor or the like to release the primary latch 18.

To substantially prevent the ingress of dirt and moisture into the body of the primary latch 18, the housing 24 includes an additional cover part that mates with the part 24a and encloses the majority of the moving parts.

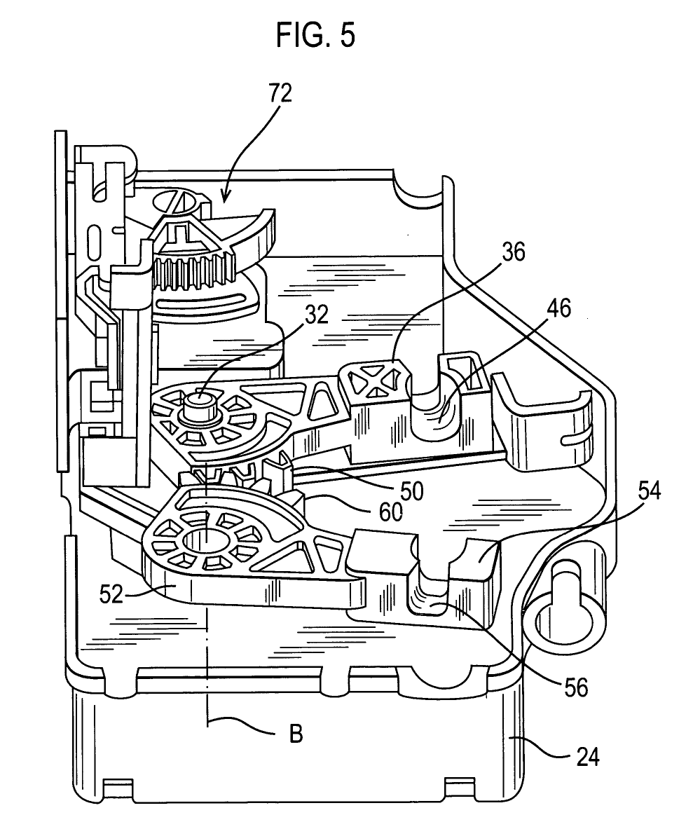

Operation of the primary latch 18 is as follows. With the primary latch 18 in an unlocked state, a vehicle user may pull on either the outside handle 23 or the inside handle 68, which actuation ultimately results in the rotation of the pawl lifter 36 in a clockwise direction when viewed in FIGS. 5 and 6. This causes the pawl 29 to disengage the claw 28 by virtue of the lost motion abutment and the lug connection 40 and 42. Additionally, rotation of the pawl lifter 36 actuates the Bowden cable 48, thus releasing the upper secondary latch 20. By virtue of the meshing of gear quadrants 50 and 60, the auxiliary release lever 52 is caused to rotate counter-clockwise, thus actuating the lower supplementary latch 20 via the Bowden cable 58. Therefore, the above-described latch release mechanism causes release of the primary latch 18, as well as the simultaneous or near simultaneous, release of supplementary upper and lower secondary latches 20 to permit release of the first rear door 12 to which all three latches are fitted.

That terms such as upper and lower, clockwise and counter-clockwise are used for ease of description only, and should not be considered as being limiting.

It will be appreciated that numerous changes may be made within the scope of the present invention. For example, the gear mechanism may be replaced by alternative suitable linkages such as a link pivotably mounted to both the release lever and the auxiliary release lever to cause synchronous rotational movement of the levers in opposite directions. Additionally, the levers may be adapted so that alternative linkages, such as solid rods, as opposed to Bowden cables may connect them to the supplementary latches (in which case the recesses could be replaced by bores through the release levers that rods bolt or clip to). The pawl itself may be used as the release lever, rather than the pawl lifter and a slot or other suitable means providing a lost motion connection may be provided in the pawl or elsewhere in the linkage. The supplementary latches may be replaced by other supplementary retention means such as shoot bolts and the general layout of the latch may be adjusted in order to fit into different space envelopes. The invention is not limited to use on van rear doors and may also be applied to other vehicle closures that require securing at more than one location.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A latch release mechanism for a vehicle door latch, the latch release mechanism comprising:
a release lever to transmit an input from a release actuator to a pawl of the vehicle door latch to lift the pawl and release a retention formation of the vehicle door latch, wherein the release lever includes a first attachment formation to permit the attachment of a first release linkage for a second retention formation, wherein the release lever is a pawl lifter; and
an auxiliary release lever, wherein the release lever is connected to the auxiliary release lever for synchronous motion with the auxiliary release lever, and the auxiliary release lever includes a second attachment formation to permit the attachment of a second release linkage for a third retention formation.

2. The latch release mechanism according to claim 1 wherein the synchronous motion is in opposed directions.

3. The latch release mechanism according to claim 1 wherein the synchronous motion is in rotary directions.

4. The latch release mechanism according to claim 1 further including a gear mechanism to control the synchronous motion.

5. The latch release mechanism according to claim 4 wherein the gear mechanism is integrally provided on at least one of the release lever and the auxiliary release lever.

6. The latch release mechanism according to claim 5 wherein the gear mechanism is integrally provided on both the release lever and the auxiliary release lever.

7. The latch release mechanism according to claim 1 wherein a lost motion connection is provided between the pawl and the release lever.

8. A latch release mechanism for a vehicle door latch, the latch release mechanism comprising:
a release lever to transmit an input from a release actuator to a pawl of the vehicle door latch to lift the pawl and release a retention formation of the vehicle door latch, wherein the release lever includes a first attachment formation to permit the attachment of a release linkage for a second retention formation; and
an auxiliary release lever, wherein the release lever is connected to the auxiliary release lever for synchronous motion with the auxiliary release lever, wherein the auxiliary release lever includes a second attachment formation to permit the attachment of a second release linkage for a third retention formation,
wherein at least one of the first attachment formation and the second attachment formation is configured to attach a Bowden cable to the at least one of the first attachment formation and the second attachment formation.

9. The latch release mechanism according to claim 8 wherein the Bowden cable includes an enlarged end and the at least one of the first attachment formation and the second formation is a recess to receive the enlarged end of the Bowden cable.

10. The latch release mechanism according to claim 8 wherein at least one of the second retention formation and the third retention formation is a second latch and a third latch, respectively.

11. A door latch array comprising:
a primary latch incorporating a latch release mechanism for a vehicle door latch, the latch release mechanism including:
a release lever to transmit an input from a release actuator to a pawl of the primary latch to lift the pawl and release a retention formation of the primary latch, wherein the release lever includes a first attachment formation to permit the attachment of a first release linkage for a second retention formation, wherein the release lever is a pawl lifter, and
an auxiliary release lever, wherein the release lever is connected to the auxiliary release lever for synchronous motion with the auxiliary release lever, wherein the auxiliary release lever includes a second attachment formation to permit the attachment of a second release linkage for a third retention formation; and
the second retention formation and the third retention formation, wherein a first linkage and a second linkage, respectively, connects the second retention formation and the third retention formation, respectively, to the primary latch.

12. The array according to claim 11 wherein at least one of the second retention formation and the third retention formation is a second latch and a third latch, respectively.
